(19) United States
(12) Patent Application Publication
(10) Pub. No.: US 2013/0180859 A1
(43) Pub. Date: Jul. 18, 2013

(54) WATER TREATMENT REACTOR

(71) Applicant: HUAZHONG UNIVERSITY OF SCIENCE AND TECHNOLOGY, Wuhan (CN)

(72) Inventors: Zhenghao HE, Wuhan (CN); Yuhang XU, Wuhan (CN); Lu ZHU, Wuhan (CN); Junxiang LIU, Wuhan (CN); Zhaoliang ZHANG, Wuhan (CN); Runkai GUO, Wuhan (CN)

(73) Assignee: HUAZHONG UNIVERSITY OF SCIENCE AND TECHNOLOGY, Wuhan (CN)

(21) Appl. No.: 13/784,853

(22) Filed: Mar. 5, 2013

Related U.S. Application Data
(63) Continuation-in-part of application No. PCT/CN2011/073853, filed on May 10, 2011.

(30) Foreign Application Priority Data
Sep. 6, 2010 (CN) 201010273294.7

(51) Int. Cl. C02F 1/46

(52) U.S. Cl. CPC C02F 1/4608
USPC 204/660

(57) ABSTRACT

A water treatment reactor, including: a reaction vessel; an electrode; a pulsed power supply; and a regulating assembly, the regulating assembly including a fixation cylinder, an insulation sleeve, and a copper cap. The pulsed power supply is in electric connection with the electrode. The fixation cylinder is fixed on a vessel wall of the reaction vessel. The insulation sleeve is disposed between the electrode and the fixation cylinder. The copper cap is disposed outside the insulation sleeve. An inner flange is disposed on one end of the copper cap. A protrusion is disposed on a middle part of the insulation sleeve and is sandwiched between the vessel wall and the inner flange of the copper cap. The protrusion includes at least two sections; and a rubber ring is disposed between two adjacent sections. The copper cap and the fixation cylinder are in a threaded connection.

### CROSS-REFERENCE TO RELATED APPLICATIONS

This application is a continuation-in-part of International Patent Application No. PCT/CN2011/073853 with an international filing date of May 10, 2011, designating the United States, now pending, and further claims priority benefits to Chinese Patent Application No. 201010273294.7 filed Sep. 6, 2010. The contents of all of the aforementioned applications, including any intervening amendments thereto, are incorporated herein by reference. Inquiries from the public to applicants or assignees concerning this document or the related applications should be directed to: Matthias Scholl P.C., Attn.: Dr. Matthias Scholl Esq., 14781 Memorial Drive, Suite 1319, Houston, Tex. 77079.

### BACKGROUND OF THE INVENTION

1. Field of the Invention

The invention relates to a field of water treatment, and more particularly to a water treatment reactor using pulsed power.

2. Description of the Related Art

Pulsed discharge in a liquid is characterized in that a great shock wave and a violent ultraviolet light are produced to form a high-temperature and high-pressure plasma channel, as well as a large amount of ions and free radicals. The combined action of these processes has a significant effect in treating bacteria, planktons, and mollusks in the water.

A typical water treatment reactor using pulsed power includes: a reaction vessel, an electrode, and a pulsed power supply connected to the electrode. To meet different requirements on water treatment, the electrodes of different materials are adopted or the distance between the electrodes is adjusted. However, in a typical water treatment reactor, the electrode is irremovably fixed on the reaction vessel. To displace the electrode, the whole reaction vessel is required to displace; or the electrode is fixed on the reaction vessel via a flange, to displace the electrode or adjust the distance between the electrodes, the electrode together with the flange are required to displace, resulting in inconvenience in operation and increase of the production cost.

### SUMMARY OF THE INVENTION

In view of the above-described problems, it is one objective of the invention to provide a water treatment reactor using pulsed power that is simple in structure, and convenient to displace the electrodes or adjust the distance between two electrodes.

To achieve the above objective, in accordance with one embodiment of the invention, there is provided a water treatment reactor. The water treatment reactor comprises: a reaction vessel, the reaction vessel comprising: a vessel wall, a water outlet, and a water inlet; an electrode; a pulsed power supply; and a regulating assembly, the regulating assembly comprising: a fixation cylinder, an insulation sleeve comprising a protrusion and a rubber ring, and a copper cap comprising an inner flange. The pulsed power supply is in electric connection with the electrode. The fixation cylinder is fixed on the vessel wall. The insulation sleeve is disposed between the electrode and the fixation cylinder. The copper cap is disposed outside the insulation sleeve. The inner flange of the copper cap is disposed on one end of the copper cap. The protrusion is disposed on a middle part of the insulation sleeve and is sandwiched between the vessel wall and the inner flange of the copper cap. The protrusion comprises at least two sections; the rubber ring is disposed between two adjacent sections of the protrusion. The copper cap and the fixation cylinder are in a threaded connection.

Compared with the prior art, the water treatment reactor of the invention comprises the regulating assembly. The regulating assembly comprises the fixation cylinder fixed on the vessel wall, the insulation sleeve, and the copper cap. The protrusion is arranged on the middle part of the insulation sleeve. The protrusion comprises at least two sections, and the rubber ring is disposed between two sections of the protrusion. The insulation sleeve is disposed outside the electrode, and inserted into the fixation cylinder. After that, the copper cap is disposed outside the insulation sleeve. The copper cap and the fixation cylinder are connected by threads, so that the protrusion is sandwiched between one end of the copper cap, i.e., the inner flange, and the reaction vessel. When the copper cap is fastened, a force is imposed on the protrusion of the insulation sleeve, and the rubber ring is pressed and deformed. Thus, the electrode is fixed by the rubber ring. In the meanwhile, the waterproof ability of the structure is realized. This structure is convenient to displace electrodes with different materials in compliance with different requirements of water treatment, and is simple to adjust the distance of the electrodes to realize different discharge effects. Furthermore, the water treatment reactor of the invention has a simple structure, low production cost, significant effect in water treatment, and is widely applicable in a small scale water treatment reactor using pulsed power.

In a class of this embodiment, the protrusion comprises three sections; two rubber rings are provided; and each of the rubber rings is disposed between two adjacent sections of the protrusion for further fixing the electrode and improving the waterproof property.

In a class of this embodiment, the regulating assembly further comprises an insulation layer; and the insulation layer is disposed between the inner flange of the copper cap and the insulation sleeve. Thus, the copper cap is insulated from the electrode.

In a class of this embodiment, the insulation sleeve is made of polytetrafluoroethylene for achieving a good stress intensity and insulation effect.

In a class of this embodiment, the insulation layer is made of polytetrafluoroethylene for assuring a good insulation between the copper cap and the electrode.

In a class of this embodiment, the reaction vessel is made of stainless steel and is in a cylindrical structure. This structure is helpful to allow the water to flow inside the reaction vessel, and is capable of reflecting the pressure wave and intensifying the effect of the electric discharge.

In a class of this embodiment, at least two pairs of electrodes are provided; each pair of electrodes is different from one another in a distance between an axle of the pair of electrodes and an axial section of the reaction vessel; and the axial section of the reaction vessel is in parallel with the axle of each pair of electrodes. The arrangement of different pairs of electrodes is helpful for the pressure wave to reflect and superpose in the reaction vessel and further improve the effect of sterilization.

In a class of this embodiment, an outlet valve and an inlet valve are disposed at the water outlet and the water inlet, respectively. The outlet valve and the inlet valve are used to adjust the flow speed of the water, control the time of water treatment, and further improve the quality of the water after the treatment.

In a class of this embodiment, the reaction vessel further comprises a hole for inserting a water quality test probe to measure of the water quality before and after the water treatment.

In a class of this embodiment, the reaction vessel further comprises an inspection window for observing the electric discharge of the electrodes.

### BRIEF DESCRIPTION OF THE DRAWINGS

The invention is described hereinbelow with reference to the accompanying drawings, in which:

FIG. 1 is a structure diagram of a water treatment reactor in accordance with one embodiment of the invention;

FIG. 2 is a sectional view taken from line A-A of FIG. 1;

FIG. 3 is an enlarged view of a regulating assembly and an electrode of a water treatment reactor in accordance with one embodiment of the invention;

FIG. 4 is a sectional view of an insulation sleeve of a regulating assembly in accordance with one embodiment of the invention;

FIG. 5 is a structure diagram of a fixation cylinder of a regulating assembly in accordance with one embodiment of the invention; and

FIG. 6 is a structure diagram of a copper cap of a regulating assembly in accordance with one embodiment of the invention.

### DETAILED DESCRIPTION OF THE EMBODIMENTS

To further illustrate the invention, experiments detailing a water treatment reactor using pulsed power are described below. The water treatment reactor is simple in structure, and convenient to displace the electrode or adjust the distance between two electrodes. It should be noted that the following examples are intended to describe and not limited to the invention.

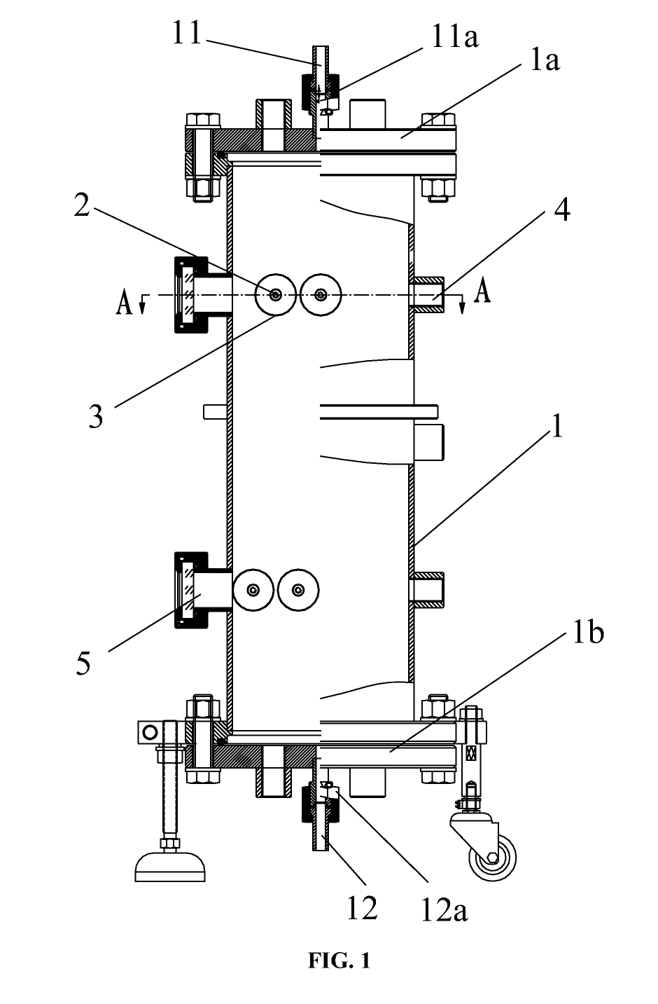

As shown in FIG. 1, a water treatment reactor using pulsed power comprises: a reaction vessel 1, an electrode 2, a regulating assembly 3, and a pulsed power supply (not shown in FIGS. 1-6) that is in electric connection with the electrode 2. The reaction vessel 1 comprises a water outlet 11 and a water inlet 12. Specifically, the reaction vessel 1 is made of stainless steel and is in a cylindrical structure. Two cover plates 1a, 1b are disposed on two ends of the reaction vessel 1, respectively. The water outlet 11 is disposed on a middle part of the cover plate 1a, and the water inlet 12 is disposed on a middle part of the cover plate 1b. An outlet valve 11a is arranged at the water outlet 11, and an inlet valve 12a is arranged at the water inlet 12. A flow speed of the water inside the reaction vessel 1 can be regulated by adjusting the outlet valve 11a and the inlet valve 12a to assure the time and the quality of the water treatment.

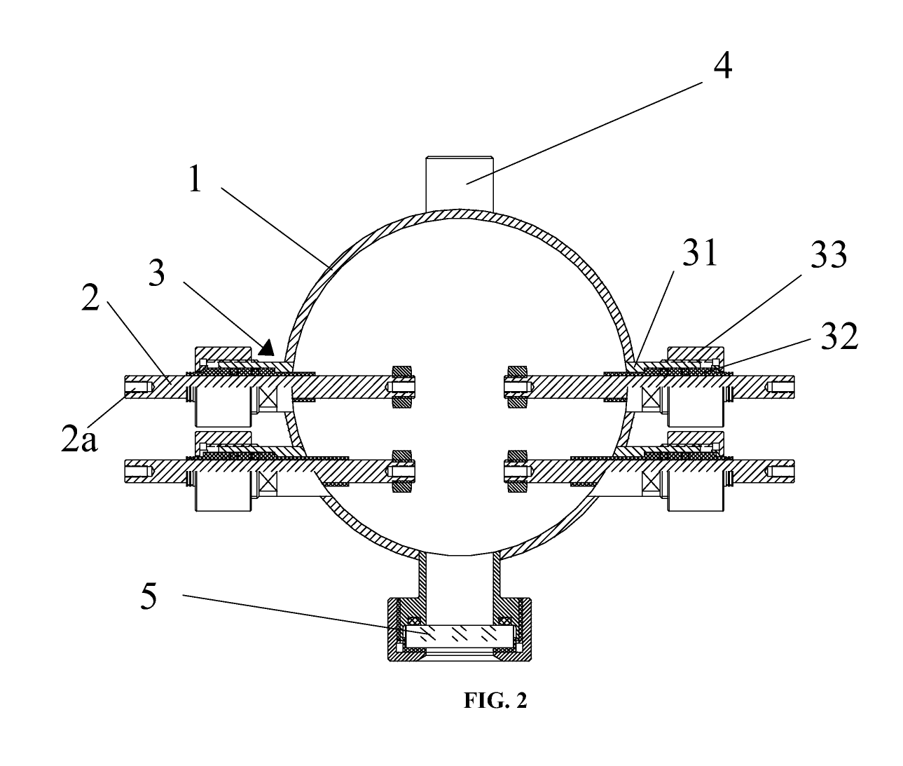

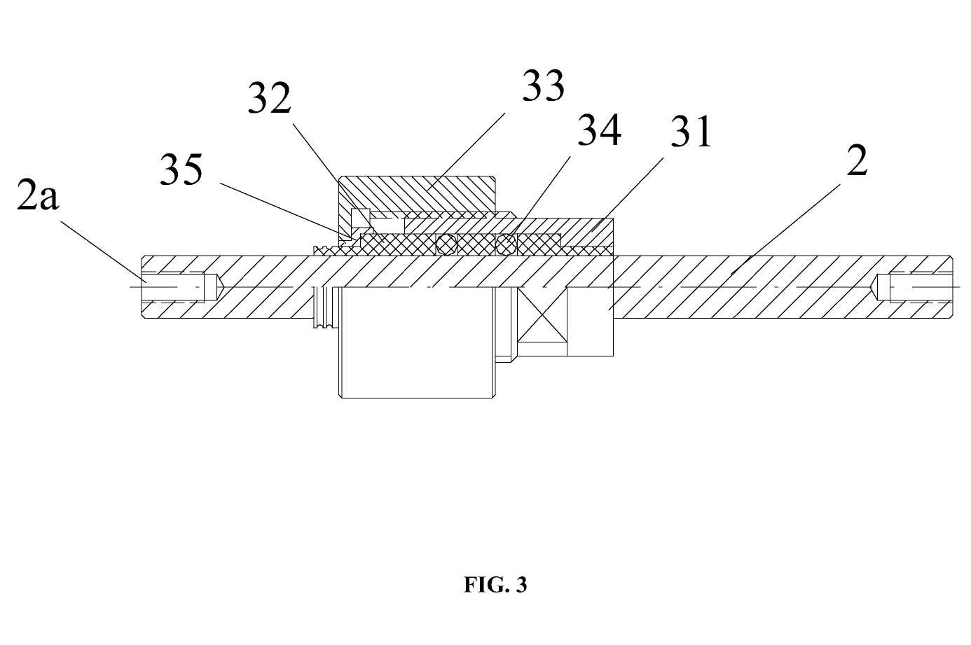

As shown in FIG. 1, four pairs of electrodes 2 are provided. Each pair of electrodes 2 is different from one another in a distance between an axle of the pair of electrodes 2 and an axial section of the reaction vessel 1; and the axial section of the reaction vessel 1 is in parallel with the axle of each pair of electrodes 2. The arrangement of different pairs of electrodes is helpful for the pressure wave to reflect and superpose in the reaction vessel and further improve the effect of sterilization. Specifically, as shown in FIGS. 2 and 3, the electrode 2 is fixed on the reaction vessel 1 via the regulating assembly 3. The electrode 2 comprises two ends, and two thread grooves 2a are arranged on two ends of the electrode 2, respectively. One end of the electrode 2 that is disposed outside the reaction vessel is connected to the pulsed power supply via the corresponding thread groove 2a. Also, the thread groove 2a can be arranged on only one end of the electrode 2.

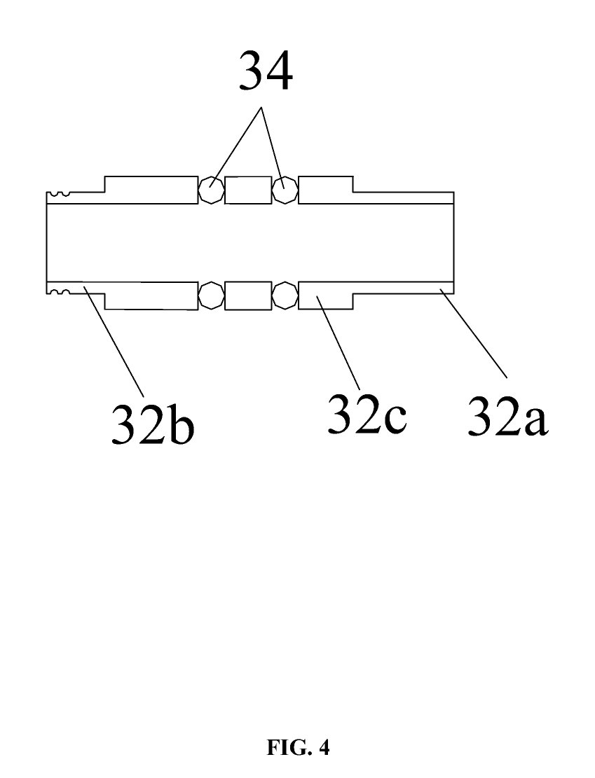

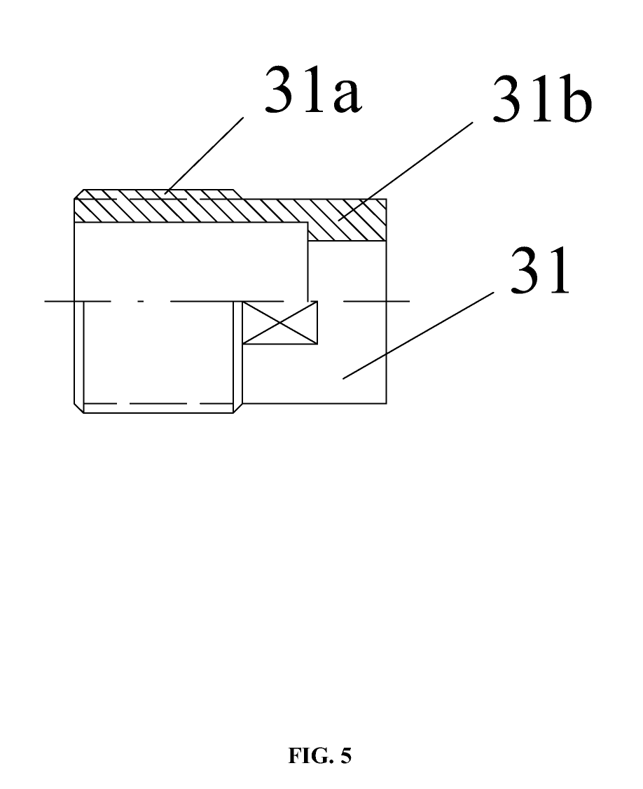

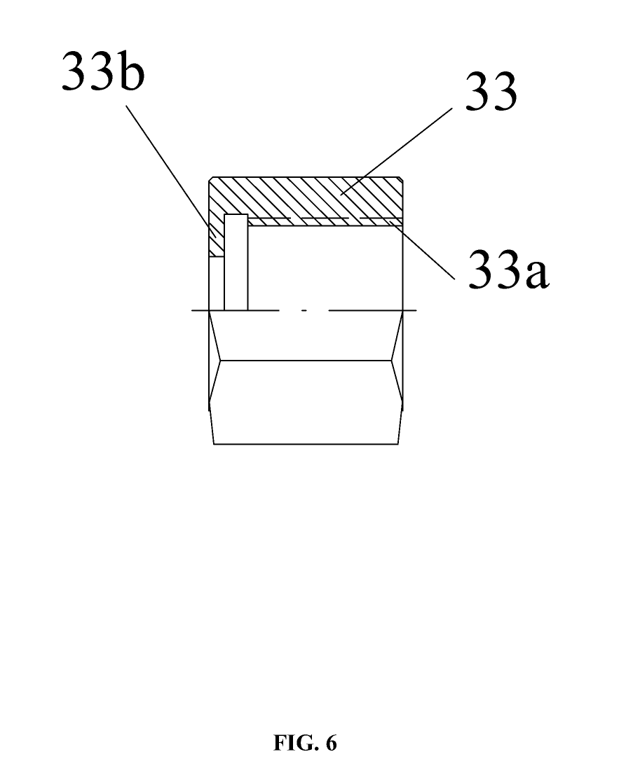

The regulating assembly 3 comprises: a fixation cylinder 31, an insulation sleeve 32, and a copper cap 33. As shown in FIG. 5, the fixation cylinder 31 is in a cylindrical structure and comprises two ends, one end of the fixation cylinder 31 is fixed on a vessel wall, and the other end of the fixation cylinder 31 comprises an outer wall on which an outer thread 31a is disposed. As shown in FIG. 4, the protrusion 32c is disposed on a middle part of the insulation sleeve 32. The insulation sleeve 32 comprises a protrusion 32c and a rubber ring 34. The protrusion 32c comprises three sections. The rubber ring 34 is disposed between two adjacent sections of the protrusion 32c. Preferably, the insulation sleeve 32 is made of polytetrafluoroethylene for assuring a good stress intensity and insulation effect. The number of the rubber ring 34 is not limited to two, and is designed according to the practical requirements for the purpose of fixation of the electrode and waterproof. The insulation sleeve 32 is disposed outside the electrode 2 and inside the fixation cylinder 31. The copper cap is disposed outside the insulation sleeve 32. The insulation sleeve 32 comprise two ends, one end of the insulation sleeve 32 is inserted into the reaction vessel 1, and the other end of the insulation sleeve 32 is disposed inside the copper cap 33. The copper cap 33 comprises two ends, one end of the copper cap 33 comprises an inner thread 33a, and the other end of the copper cap 33 comprises an inner flange 33b, as shown in FIG. 6. The protrusion 32c of the insulation sleeve 32 is sandwiched between the vessel wall and the inner flange 33b of the copper cap 33. Furthermore, an inner lug boss 31b is formed at one end of the fixation cylinder 31 that is connected to the reactor vessel 1. As shown in FIG. 5, the protrusion 32c of the insulation sleeve 32 is fixed between the vessel wall and the inner flange 33b of the copper cap 33 via the inner flange 33b of the copper cap 33 and the inner lug boss 31b of the fixation cylinder 31.

The insulation sleeve 32 is disposed outside the electrode 2, and inserted into the fixation cylinder 31. After that, the copper cap 33 is disposed outside the insulation sleeve 32, and the copper cap 33 and the fixation cylinder 31 are connected via the inner thread 33a and the outer thread 31a. When the copper cap 33 is fastened by the insulation sleeve 33, the insulation sleeve 32 is pressed by the inner flange 33b of the copper cap 33 and the vessel wall, a force is imposed on the protrusion 32c of the insulation sleeve 32, and the rubber ring 34 is pressed and deformed. Thus, the electrode 2 is fixed by the rubber ring 34; in the meanwhile, the waterproof ability of the structure is realized. To displace the electrode 2 or adjust the distance between the electrodes 2, it is required to unfasten the copper cap 33 to allow the rubber ring 34 to return to an original state. After displacing the electrode or adjusting the position of the electrode, the electrode is fixed by fastening the copper cap 33. The structure is simple and convenient to operate. After the electrode 2 is fixed by the regulating assembly 3, water to be treated is introduced into the reaction vessel 1, and the pulsed power supply is turned on. Energy is discharged via the electrodes 2, and the space between the electrodes 2 is broken down. Thus, a pulse of electric discharge is realized. When the space between the electrodes 2 is broken down, a great shock wave and a violent ultraviolet light are produced to form a high-temperature and high-pressure plasma channel, as well as a large amount of ions and free radicals. The water is treated by the combined action of these processes. When the treatment is finished, the water flows out of the reaction vessel 1.

Preferably, the regulating assembly 3 further comprises an insulation layer 35; and the insulation layer 35 is disposed between the inner flange 33a of the copper cap 33 and the insulation sleeve 32. Thus, the copper cap 33 is insulated from the electrode 2. Preferably, the insulation layer 35 is made of polytetrafluoroethylene.

The reaction vessel 1 further comprises a hole 4 and an inspection window 5. The hole 4 is used for inserting a water quality test probe to measure the water quality before and after the water treatment. The inspection window 5 is used for observing the electric discharge of the electrodes. According to the electric discharge of the electrodes, suitable materials of the electrode can be selected, and the distance between the electrodes can be suitably adjusted.

In this example, the reaction vessel 1 is provided with four pairs of electrodes, three holes 3 for inserting the water quality test probe, and two inspection windows 5. However, the number and the position of the pair of the electrode 2, the holes 3, and inspection windows 5 are not limited to the example, and can be designed according to the practical requirements.

While particular embodiments of the invention have been shown and described, it will be obvious to those skilled in the art that changes and modifications may be made without departing from the invention in its broader aspects, and therefore, the aim in the appended claims is to cover all such changes and modifications as fall within the true spirit and scope of the invention.

The invention claimed is:

1. A water treatment reactor, comprising:
a) a reaction vessel, the reaction vessel comprising: a vessel wall, a water outlet, and a water inlet;
b) an electrode;
c) a pulsed power supply; and
d) a regulating assembly, the regulating assembly comprising: a fixation cylinder, an insulation sleeve comprising a protrusion and a rubber ring, and a copper cap comprising an inner flange;
wherein
the pulsed power supply is in electric connection with the electrode;
the fixation cylinder is fixed on the vessel wall;
the insulation sleeve is disposed between the electrode and the fixation cylinder;
the copper cap is disposed outside the insulation sleeve;
the inner flange of the copper cap is disposed on one end of the copper cap;
the protrusion is disposed on a middle part of the insulation sleeve and is sandwiched between the vessel wall and the inner flange of the copper cap;
the protrusion comprises at least two sections; the rubber ring is disposed between two adjacent sections of the protrusion; and
the copper cap and the fixation cylinder are in a threaded connection.

2. The water treatment reactor of claim 1, wherein the protrusion comprises three sections; two rubber rings are provided; and each of the rubber rings is disposed between two adjacent sections of the protrusion.

3. The water treatment reactor of claim 1, wherein the regulating assembly further comprises an insulation layer, and the insulation layer is disposed between the inner flange of the copper cap and the insulation sleeve.

4. The water treatment reactor of claim 2, wherein the regulating assembly further comprises an insulation layer, and the insulation layer is disposed between the inner flange of the copper cap and the insulation sleeve.

5. The water treatment reactor of claim 3, wherein the insulation sleeve is made of polytetrafluoroethylene.

6. The water treatment reactor of claim 4, wherein the insulation sleeve is made of polytetrafluoroethylene.

7. The water treatment reactor of claim 3, wherein the insulation layer is made of polytetrafluoroethylene.

8. The water treatment reactor of claim 4, wherein the insulation layer is made of polytetrafluoroethylene.

9. The water treatment reactor of claim 1, wherein the reaction vessel is made of stainless steel and is in a cylindrical structure.

10. The water treatment reactor of claim 9, wherein
at least two pairs of electrodes are provided;
each pair of electrodes is different from one another in a distance between an axle of the pair of electrodes and an axial section of the reaction vessel; and
the axial section of the reaction vessel is in parallel with the axle of each pair of electrodes.

11. The water treatment reactor of claim 1, wherein an outlet valve and an inlet valve are disposed at the water outlet and the water inlet, respectively.

12. The water treatment reactor of claim 2, wherein an outlet valve and an inlet valve are disposed at the water outlet and the water inlet, respectively.

13. The water treatment reactor of claim 1, wherein the reaction vessel further comprises an inspection window for observing an electric discharge of the electrodes.

14. The water treatment reactor of claim 2, wherein the reaction vessel further comprises an inspection window for observing an electric discharge of the electrodes.

15. The water treatment reactor of claim 1, wherein the reaction vessel further comprises a hole for inserting a water quality test probe.

16. The water treatment reactor of claim 2, wherein the reaction vessel further comprises a hole for inserting a water quality test probe.
